(19) United States
(12) Patent Application Publication
(10) Pub. No.: US 2014/0265938 A1
(43) Pub. Date: Sep. 18, 2014

(54) ILLUMINATION APPARATUS AND METHOD FOR CONTROLLING ILLUMINATION OF THE ILLUMINATION APPARATUS

(71) Applicant: Chiun Mai Communication Systems, Inc., New Taipei (TW)

(72) Inventor: PO-YEN LIU, New Taipei (TW)

(73) Assignee: CHIUN MAI COMMUNICATION SYSTEMS, INC., New Taipei (TW)

(21) Appl. No.: 14/203,254

(22) Filed: Mar. 10, 2014

(30) Foreign Application Priority Data
Mar. 12, 2013 (TW) 102108583

(51) Int. Cl. H05B 37/02

(52) U.S. Cl. CPC H05B 37/02
USPC 315/362

(57) ABSTRACT

In a method for controlling illumination of at least one illumination apparatus, the illumination apparatus communicates with one or more mobile devices. The method determines whether at least one of the mobile devices enters into an effective range of a BLUETOOTH unit of the illumination apparatus, and turns on a light source of the illumination apparatus when at least one the mobile devices enters into the effective range of the BLUETOOTH unit. The method further determines whether all of the mobile devices are out of the effective range of the BLUETOOTH unit, and turns off the light source of the illumination apparatus when all of the mobile devices are out of the effective range of the BLUETOOTH unit.

### BACKGROUND

1. Technical Field

Embodiments of the present disclosure relate to illumination technologies, and particularly to an illumination apparatus and a method for controlling illumination of the illumination apparatus.

2. Description of Related Art

Illumination apparatuses are usually used to provide light for people, for example, a street light illuminates an area of a road for safety. In order to save energy, an induction lamp can be used as the street light. The induction lamp may be turned on by, but is not limited to, the voice of someone or infrared radiation of a person. However, the induction lamp is expensive, and may turn on or off inadvertently due to changes in the ambient environment. Therefore, there is room for improvement in the art.

### BRIEF DESCRIPTION OF THE DRAWINGS

FIG. 1 is a schematic diagram of one embodiment of an illumination apparatus comprising an illumination controlling system.

FIG. 2 is a flowchart illustrating one embodiment of a method for controlling illumination of the illumination apparatus of FIG. 1.

### DETAILED DESCRIPTION

The disclosure, comprising the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may comprise CDs, DVDs, BLU-RAY, flash memory, and hard disk drives.

FIG. 1 is a schematic diagram of one embodiment of an illumination apparatus 100 comprising an illumination controlling system 10. The illumination apparatus 100 can be, but is not limited to, a street light or an electric lamp. The illumination apparatus 100 communicates with one or more mobile devices 300 (only two shown in FIG. 1) through a BLUETOOTH communication protocol 200. Each of the mobile devices 300 can be, but is not limited to, a notebook computer, a mobile phone, or a personal digital assistant (PDA). Each of the mobile devices 300 further comprises a BLUETOOTH module 50. The BLUETOOTH module 50 communicates with the illumination apparatus 100 through the BLUETOOTH communication protocol 200.

The illumination apparatus 100 further comprises a BLUETOOTH unit 30, a light source 40, a storage system 20 and a processor 60. The BLUETOOTH unit 30 communicates with the BLUETOOTH module 50 through the BLUETOOTH communication protocol 200. The light source 40 provides light, for example, a bulb of the street light. The storage system 20 can be a memory (e.g., random access memory, or flash memory) of the illumination apparatus 100. The processor 60 executes one or more computerized codes and other applications of the illumination apparatus 100 to provide functions of the illumination controlling system 10. The illumination controlling system 10 is used to turn on or turn off the light source 40 of the illumination apparatus 100.

When at least one of the mobile devices 300 enters into an effective range of the BLUETOOTH unit 30 of the illumination apparatus 100, the illumination controlling system 10 turns on the light source 40 of the illumination apparatus 100. The effective range is determined by the transmission power of the BLUETOOTH unit 30. The effective range can vary depending on class of radio used in the BLUETOOTH unit 30, for example, Class 3 radios having a range of up to one meter, or Class 2 radios having a range of ten meters. When the transmission power is 2.5 milliwatts (mW), then the most commonly used radio Class 2 is using, and the effective range is ten meters. When all of the mobile devices 300 are out of the effective range of the BLUETOOTH unit 30 of the illumination apparatus 100, the illumination controlling system 10 turns off the light source 40 of the illumination apparatus 100.

In the embodiment, the illumination controlling system 10 comprises a determination module 11, an opening module 12, and a closing module 13. The modules 11-13 comprise computerized codes in the form of one or more programs that are stored in the storage system 20. The computerized codes comprise instructions that are executed by the processor 60 to provide functions of the modules 11-13.

The determination module 11 determines whether at least one of the mobile devices 300 enters into the effective range of the BLUETOOTH unit 30 of the illumination apparatus 100. In the embodiment, the determination module 11 turns on the BLUETOOTH unit 30 of the illumination apparatus 100 and the BLUETOOTH module 50 of each of the mobile devices 300 initially.

In the embodiment, the determination module 11 determines whether one or more BLUETOOTH modules 50 are in the effective range of the BLUETOOTH unit 30. When at least one of the BLUETOOTH modules 50 is in the effective range of the BLUETOOTH unit 30, the determination module 11 determines that at least one of the mobile devices 300 enters into the effective range of the BLUETOOTH unit 30. When none of the BLUETOOTH modules 50 is in the effective range of the BLUETOOTH unit 30, the determination module 11 determines that all of the mobile devices 300 are out of the effective range of the BLUETOOTH unit 30.

When at least one of the mobile devices 300 enters into the effective range of the BLUETOOTH unit 30, the opening module 12 turns on the light source 40 of the illumination apparatus 100. In the embodiment, the closing module 13 turns off the light source 40 initially.

The determination module 11 also determines whether all of the mobile devices 300 are out of the effective range of the BLUETOOTH unit 30.

When all of the mobile devices 300 are out of the effective range of the BLUETOOTH unit 30, the closing module 13 turns off the light source 40 of the illumination apparatus 100.

In the embodiment, each BLUETOOTH unit 30 controls illumination of one or more illumination apparatuses 100, that is to say, turns on or turns off light sources 40 of the one or more illumination apparatuses 100, where each of the one or more illumination apparatuses 100 comprise one light source 40. For example, if each illumination apparatus 100 comprises a BLUETOOTH unit 30, then each BLUETOOTH unit 30 just controls the one illumination apparatus 100. In order to reduce the cost for producing the illumination apparatuses 100, one BLUETOOTH unit 30 is used to control more than one illumination apparatuses 100 in the effective range (e.g., 10 meters) of the one BLUETOOTH unit 30. For example, if the more than one illumination apparatuses 100 share the one BLUETOOTH unit 30, then the one BLUETOOTH unit 30 controls the more than one illumination apparatuses 100. Turning on or turning off light sources 40 of the more than one illumination apparatuses 100 can implement by changing the circuit design of the more than one illumination apparatuses 100.

FIG. 2 is a flowchart illustrating one embodiment of a method for controlling illumination of the illumination apparatus 100. Depending on the embodiment, additional steps may be added, others deleted, and the ordering of the steps may be changed.

In step S10, the determination module 11 determines whether at least one of the mobile devices 300 enters into the effective range of the BLUETOOTH unit 30 of the illumination apparatus 100. If at least one of the mobile devices 300 enters into the effective range of the BLUETOOTH unit 30, step S20 is implemented. If none of the mobile devices 300 enters into the effective range of the BLUETOOTH unit 30, step S10 is repeated. In the embodiment, the determination module 11 turns on the BLUETOOTH unit 30 of the illumination apparatus 100 and the BLUETOOTH module 50 of each of the mobile devices 300 at the beginning of the procedure.

In step S20, the opening module 12 turns on the light source 40 of the illumination apparatus 100. In the embodiment, the closing module 13 turns off the light source 40 at the beginning of the procedure.

In step S30, the determination module 11 determines whether all of the mobile devices 300 are out of the effective range of the BLUETOOTH unit 30. If all of the mobile devices 300 are out of the effective range of the BLUETOOTH unit 30, step S40 is implemented. If at least one of the mobile devices 300 is still in the effective range of the BLUETOOTH unit 30, step S30 is repeated.

In step S40, the closing module 13 turns off the light source 40 of the illumination apparatus 100.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be comprised herein within the scope of this disclosure and the described inventive embodiments, and the present disclosure is protected by the following claims.

What is claimed is:

1. A method for controlling illumination of at least one illumination apparatus that communicates with one or more mobile devices, the method comprising:
determining whether at least one of the mobile devices enters into an effective range of a BLUETOOTH unit of the illumination apparatus;
turning on a light source of the illumination apparatus when at least one of the mobile devices enters into the effective range of the BLUETOOTH unit;
determining whether all of the mobile devices are out of the effective range of the BLUETOOTH unit; and
turning off the light source of the illumination apparatus when all of the mobile devices are out of the effective range of the BLUETOOTH unit.

2. The method as described in claim 1, wherein the effective range is determined by a transmission power of the BLUETOOTH unit.

3. The method as described in claim 1, before determining whether at least one of the mobile devices enters into the effective range of the BLUETOOTH unit, the method further comprising:
turning on the BLUETOOTH unit of the illumination apparatus and a BLUETOOTH module of each of the mobile devices.

4. The method as described in claim 1, wherein the step of determining whether at least one of the mobile devices enters into the effective range of the BLUETOOTH unit comprising:
determining whether one or more BLUETOOTH modules of the mobile devices are in the effective range of the BLUETOOTH unit;
determining that at least one of the mobile devices enters into the effective range of the BLUETOOTH unit when at least one of the BLUETOOTH modules is in the effective range of the BLUETOOTH unit; and
determining that all of the mobile devices are out of the effective range of the BLUETOOTH unit when none of the BLUETOOTH modules is in the effective range of the BLUETOOTH unit.

5. An illumination apparatus that communicates with one or more mobile devices, the illumination apparatus comprising:
a BLUETOOTH unit;
a light source;
at least one processor; and
a computer-readable storage medium storing one or more programs that, which when executed by the at least one processor, causes the at least one processor to:
determine whether at least one of the mobile devices enters into an effective range of the BLUETOOTH unit of the illumination apparatus;
turn on the light source of the illumination apparatus when at least one of the mobile devices enters into the effective range of the BLUETOOTH unit;
determine whether all of the mobile devices are out of the effective range of the BLUETOOTH unit; and
turn off the light source of the illumination apparatus when all of the mobile devices are out of the effective range of the BLUETOOTH unit.

6. The illumination apparatus as described in claim 5, wherein the effective range is determined by a transmission power of the BLUETOOTH unit.

7. The illumination apparatus as described in claim 5, wherein the one or more programs further cause the at least one processor to:
turn on the BLUETOOTH unit of the illumination apparatus and a BLUETOOTH module of each of the mobile devices initially.

8. The mobile device as described in claim 5, wherein the one or more programs further cause the at least one processor to:
determine whether one or more BLUETOOTH modules of the mobile devices are in the effective range of the BLUETOOTH unit;
determine that at least one of the mobile devices enters into the effective range of the BLUETOOTH unit when at least one of the BLUETOOTH modules is in the effective range of the BLUETOOTH unit; and
determine that all of the mobile devices are out of the effective range of the BLUETOOTH unit when none of the BLUETOOTH modules is in the effective range of the BLUETOOTH unit.

9. A non-transitory computer readable storage medium having stored thereon instructions that, when executed by a processor of at least one illumination apparatus that communicates with one or more mobile devices, causes the processor to control illumination of the illumination apparatus, the method comprising:
determining whether at least one of the mobile devices enters into an effective range of a BLUETOOTH unit of the illumination apparatus;
turning on a light source of the illumination apparatus when at least one of the mobile devices enters into the effective range of the BLUETOOTH unit;
determining whether all of the mobile devices are out of the effective range of the BLUETOOTH unit; and
turning off the light source of the illumination apparatus when all of the mobile devices are out of the effective range of the BLUETOOTH unit.

10. The non-transitory computer readable storage medium as described in claim 9, wherein the effective range is determined by a transmission power of the BLUETOOTH unit.

11. The non-transitory computer readable storage medium as described in claim 9, before determining whether at least one of the mobile devices enters into the effective range of the BLUETOOTH unit, the method further comprises:
turning on the BLUETOOTH unit of the illumination apparatus and a BLUETOOTH module of each of the mobile devices.

12. The non-transitory computer readable storage medium as described in claim 9, wherein the step of determining whether at least one of the mobile devices enters into the effective range of the BLUETOOTH unit comprises:
determining whether one or more BLUETOOTH modules of the mobile devices are in the effective range of the BLUETOOTH unit;
determining that at least one of the mobile devices enters into the effective range of the BLUETOOTH unit when at least one of the BLUETOOTH modules is in the effective range of the BLUETOOTH unit; and
determining that all of the mobile devices are out of the effective range of the BLUETOOTH unit when none of the BLUETOOTH modules is in the effective range of the BLUETOOTH unit.
